(19) United States
(12) Patent Application Publication
(10) Pub. No.: US 2014/0147701 A1
(43) Pub. Date: May 29, 2014

(54) PERPENDICULAR MAGNETIC RECORDING MEDIUM AND METHOD OF MANUFACTURING THE SAME

(71) Applicant: KABUSHIKI KAISHA TOSHIBA, Tokyo (JP)

(72) Inventors: Takeshi IWASAKI, Tokyo (JP); Kazutaka TAKIZAWA, Kanagawa (JP); Akira WATANABE, Kanagawa (JP); Kaori KIMURA, Kanagawa (JP); Tsuyoshi ONITSUKA, Tokyo (JP)

(73) Assignee: Kabushiki Kaisha Toshiba, Tokyo (JP)

(21) Appl. No.: 13/868,562

(22) Filed: Apr. 23, 2013

(30) Foreign Application Priority Data
Nov. 29, 2012 (JP) 2012-261059

(51) Int. Cl. G11B 5/84; G11B 5/72

(52) U.S. Cl. CPC G11B 5/84; G11B 5/72; G11B 5/8408
USPC 428/835.1; 216/22

(57) ABSTRACT

A magnetic recording medium is manufactured by forming a magnetic recording layer on a substrate, forming a protective layer on the magnetic recording layer, executing a sputtering process using a target containing a first ingredient and a second ingredient to form on the protective layer a grain-state mask layer that includes grains formed of the first ingredient and grain boundaries between the grains formed of the second ingredient, etching the grain boundaries so that a projection pattern of the grains is formed, and transferring the projection pattern of the grains to the magnetic recording layer.

### CROSS-REFERENCE TO RELATED APPLICATION(S)

This application is based upon and claims the benefit of priority from Japanese Patent Application No. 2012-261059, filed on Nov. 29, 2012, the entire contents of which are incorporated herein by reference.

### FIELD

Embodiments of the present application relate to a perpendicular magnetic recording medium and a method of manufacturing the same.

### BACKGROUND

In a hard disk drive (HDD), a need for high data storage capacity has been growing every year. A conventional magnetic recording medium for an HDD has a configuration in which layers are formed evenly over an entire surface of a substrate. However, in a recording medium with a recording capacity of more than 500 Gb/in², adjacent data are stored very close to each other. Thus, when data is read from a part of the recording medium, data recorded in an adjacent part of the recording medium is unnecessarily read. Also, when data is written to a part of the recording medium, the same data is written to an adjacent part of the recording medium.

In order to solve this problem, a patterned medium has been actively researched. The patterned medium includes a magnetic film that is processed to have a predetermined pattern and a recording-reproducing head records and reproduces data based on the pattern. Forms of the pattern include a discrete track medium (DTM) and a so-called bit patterned medium (BPM). In the DTM, the recording layer is patterned in a radial direction and only a servo data part and a record track part are separated. Recording is performed in a circumferential direction by a method that is the same as the conventional method. In the BPM, the recording layer is patterned in a circumferential direction in addition to the radial pattern.

In such discrete medium (DTM) and such bit patterned medium (BPM), there is no magnetic film between tracks or between magnetization reversal units (between bits). Thus, noise is not generated from the non-recordable regions, and a signal quality (signal to noise ratio: SNR) can improve. Therefore, higher density of data can be achieved than the conventional recording medium with evenly-formed recording layer.

However, the process for patterning the recording layer has not been established, because fine patterning is required for the magnetic recording layer. A process using a mask formed by an electron beam drawing method or a self-organized mask formed from a polymer has been introduced as a patterning method. However, compared to the conventional medium that can be produced only by sputtering without patterning, the recording medium produced by such patterning methods requires a larger investment in cost and longer production time. Thus, such patterning methods are not practical for mass production.

### BRIEF DESCRIPTION OF THE DRAWINGS

FIGS. 1-8 each illustrate a sectional view of a magnetic recording medium during different steps of one example of a manufacturing process according to an embodiment.

FIGS. 9-15 each illustrate a sectional view of a magnetic recording medium during different steps of another example of the manufacturing process according to the embodiment.

### DETAILED DESCRIPTION

Embodiments provide a method of manufacturing a magnetic recording medium, which includes a projection pattern, in short time and at low cost, and the magnetic recording medium manufactured by the method.

According to an embodiment, a method of manufacturing a magnetic recording medium includes forming a magnetic recording layer on a substrate, forming a protective layer on the magnetic recording layer, executing a sputtering process using a target containing a first ingredient and a second ingredient to form a grain-state mask layer that include grains formed of the first ingredient and grain boundaries between the grains formed of the second ingredient, etching the grain boundaries so that a projection pattern of the grains is formed, and transferring the projection pattern of the grains to the magnetic recording layer.

Hereinafter, embodiments are explained in detail with reference to the drawings.

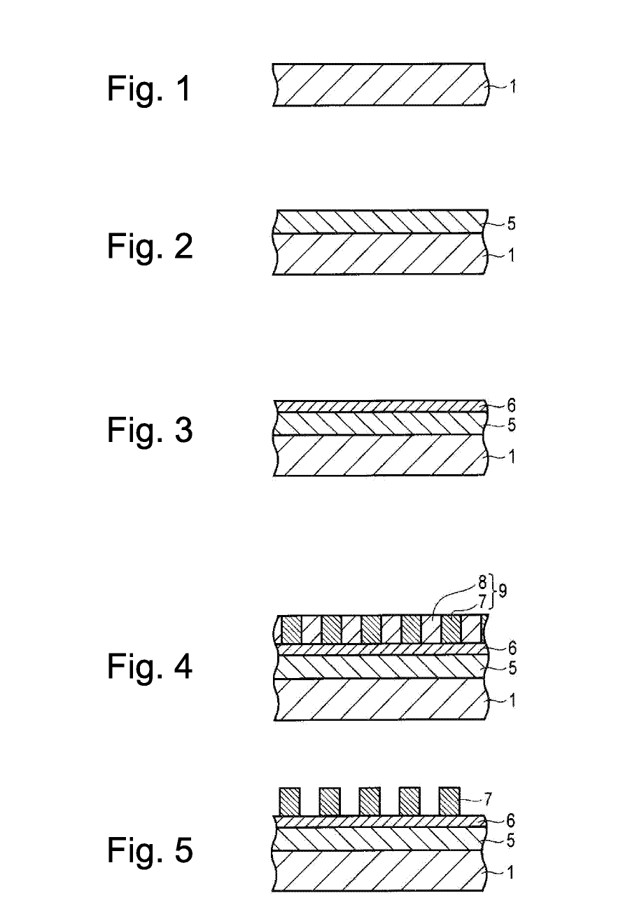

FIG. 1 through FIG. 8 illustrate manufacturing steps of a magnetic recording medium according to an embodiment.

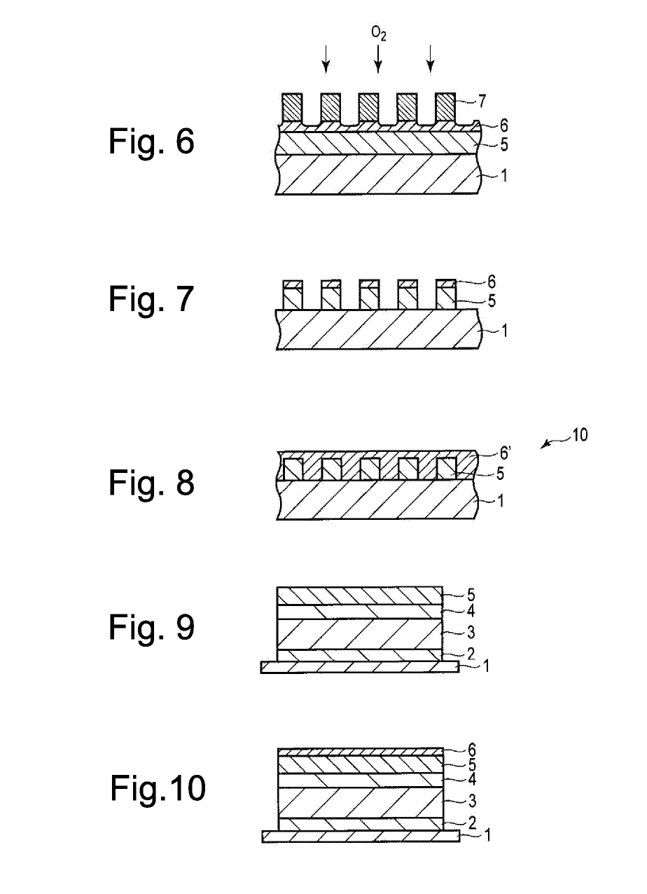

A method of manufacturing a magnetic recording medium 10 according to the embodiment includes: a step of forming a magnetic recording layer 5 on a substrate 1 illustrated in FIG. 1, as illustrated in FIG. 2; a step of forming a protective layer 6 on the magnetic recording layer 5, as illustrated in FIG. 3; a step of forming a grain-state mask layer 9 on the protective layer 6, as illustrated in FIG. 4, the grain-state mask layer 9 including grains 7 and grain boundaries 8 provided between the grains 7; a step of etching the grain boundaries 8 and forming a projection pattern of the grains 7, as illustrated in FIG. 5; and a step of transferring the projection pattern to the magnetic recording layer 5, as illustrated in FIGS. 6 and 7.

The grain-state mask layer 9 is formed using a target containing a first ingredient made from aluminum and a second ingredient made from silicon or germanium by performing a sputtering process at a pressure of 0.05 Pa through 0.3 Pa. The grains 7 of the grain-state mask layer 9 according to the present embodiment are substantially made from aluminum as the first ingredient, and the grain boundaries 8 of the grain-state mask layer 9 are substantially made from the second ingredient that is silicon or germanium. Moreover, the grains 7 of the grain-state mask layer 9 according to the present embodiment has a standard deviation σ of the grain size that is 15% or less, and an average distance between centers of the adjacent grains is 5 nm through 10 nm.

According to the present embodiment, a grain-state mask layer 9 having grains 7 whose standard deviation σ of grain size is small can be formed using a sputtering system. Moreover, all the steps of forming the grain-state mask layer 9, etching the grain boundaries 8 to form the projection pattern of the grains 7, and transferring the projection pattern of the grains 7 to the magnetic recording layer 5, can be performed using a dry process. In comparison with the case of using a wet process, it is possible to drastically reduce manufacturing cost and process time. Furthermore, further low cost and a high throughput can be realized by continuously performing these steps without exposing to the atmosphere from a vacuum.

For etching of the grain boundaries 8 made from the second ingredient, it is preferred to use various dry etching processes. Even when a wet process using acid or an alkaline solution is used, it is possible to produce a medium having a similar characteristic. However, in such wet process, there is a tendency for the production cost to increase and the throughput to be lowered. As an example of dry etching gas, CF₄, CF₄/O₂, CHF₃, and SF₆, etc., may be used.

In one embodiment, the grain boundaries 8 made from the second ingredient are etched using etching gas containing fluorine. This is because the etching gas containing fluorine selectively removes the Si or Ge grain boundaries while not removing the Al grains 7. Also, because the C protective layer 6 is formed on the magnetic recording layer 5, it is possible to protect the magnetic recording layer.

Also, as illustrated in FIG. 6, it is possible to further include a step of oxidizing surfaces of the grains 7 made from the first ingredient before the step of transferring the projection pattern of the grains 7 made from the first ingredient to the magnetic recording layer 5 by milling (FIG. 7). Because a dry etching using oxygen system gas such as O₂ and O₃ is performed before the projection pattern of the grains 7 is transferred to the magnetic recording layer 5, the projection pattern of the grains 7 can be transferred to a diamond-like carbon (DLC) protective layer 6. At this time, the surface of the aluminum grains 7 can be oxidized by heating the medium to approximately 100° C. As compared to not-oxidized metallic aluminum, oxidized aluminum has a higher tolerance to Ar milling, and a milling rate thereof is also slow, so that it is possible to have a process margin when the projection pattern is transferred to the magnetic recording layer.

Moreover, even when Si or Ge particles of the grain boundary substance remain in an initial layer part and a side wall part as a residual substance, the oxidized aluminum also has the effect of oxidizing the Si or Ge particles. The milling rates of oxidized Si and oxidized Ge are faster than those of non-oxidized Si and Ge, so that it is possible to easily remove the residual substance while milling the protective layer 6 and the magnetic recording layer 5. As for heating the medium, in addition to heating using a conventional heater, heat generated during the process may also be used when the process time is intentionally lengthened.

An average grain size of the grains 7 made from the first ingredient is 4 nm through 9 nm. When the average grain size is less than 4 nm, the processability becomes worse and this reduces the mass-productivity. Also, when the average grain size is less than 4 nm, the volume of recording dots (e.g., projections transferred to the magnetic recording layer) at the time of transferring to the magnetic recording layer is excessively small, to cause the superparamagnetic limit to be reached where thermal fluctuations in the media spontaneously switch the polarization of recorded bits. On the other hand, when the average grain size is more than 9 nm, the volume of the recording dots at the time of transferring to the magnetic recording layer is too large, and it is difficult to record data with the sufficiently high density.

Here, the grain size of the grains 7 made from the first ingredient is defined as a diameter of the grain assuming that the grain is considered to have a circular shape, and is obtained by calculating an area of the grain from a plan-view TEM (transmission electron microscope) image. Specifically, a diameter traveling through the center is measured in units of two degrees; the average value thereof is then calculated; and the average grain size and the average deviation are then obtained. Also, a length of a line connecting the centers of the grains is measured, and the average value thereof is used as a grain boundary thickness.

The sputtering process can be performed using a RF sputtering system. It is possible to easily obtain a grain-state mask layer 9 having grains 7 whose standard deviation σ of the grain size is 15% or less and whose average distance between centers is 5 nm through 10 nm when the RF sputtering system is used.

When another sputtering system such as a DC sputtering system is used, a sputtering rate (deposition rate) is too fast, and there is a tendency that the standard deviation of the grain size of the grains may not be small enough.

In order to transfer the projection pattern of the grains 7 to the magnetic recording layer 5, a portion other than a masked portion is etched by ion milling, and the projection pattern of the grains 7 is transferred onto the magnetic recording layer 5. For ion milling, a rare gas such as He, Ne, Ar, Kr, and Xe, etc., and inactive gas of N₂, etc. can be used.

The projection pattern transferred to the magnetic recording layer 5 can be embedded with an embedding material. For the embedding process, a sputtering process using the embedding material as a target is used because it is easy; however, other methods such as plating, ion beam deposition, and chemical vapor deposition (CVD), etc. may be used. When CVD is used, it is possible to form a film at a high rate on a side wall of the magnetic recording layer 5 with a high taper. Moreover, even a pattern having a high aspect ratio can also be embedded without a crevice by applying bias voltage to a substrate 1 at the time of embedding.

A protective layer 6′ can be formed after the process of the magnetic recording layer 5. It is preferred to form the protective layer 6′ by a CVD method so as to improve the coverage by the projection layer 6′; however a sputtering method or a vacuum evaporation method may be used. When the CVD method is used, a DLC film containing a lot of sp³ combined-carbon is formed as the protective layer 6′. When a film thickness thereof is 2 nm or less, the magnetic recording layer 5 is not sufficiently covered, and when the film thickness is 10 nm or more, a magnetic space between the recording-reproducing head and the magnetic recording layer 5 is large and a high SNR may not be obtained. A lubricant can be applied on the protective layer 6′. As the lubricant, perfluoropolyether, fluoroalcohol, fluorination carboxylic acid, etc. can be used, for example.

A distance between centers of the projection patterns (recording dots) of the magnetic recording layer 5, referred to as the dot pitch, can be chosen based on a required recording density. Specifically, the distance between centers of adjacent recording parts is preferably 5 nm or more and 10 nm or less.

The average grain size of each dot of the recording part can be 4 nm through 9 nm.

When the average grain size is less than 4 nm, the processability gets worse and the productivity reduces. Furthermore, the thermal fluctuation tolerance of the recording part (recording dots) gets worse to cause the superparamagnetic limit to be reached where recorded bits are spontaneously switched and data loss occurs. When the average grain size exceeds 9 nm, the processability is good, but high densities of the perpendicular magnetic recording medium cannot be realized. As the substrate 1 in the embodiment, for example, a glass substrate, an aluminum alloy substrate, a ceramic substrate, a carbon substrate, single crystal silicon substrate having an oxidized surface, etc. can be used. As a glass substrate, amorphous glass and crystallized glass are used. The amorphous glass is, for example, soda-lime glass and aluminosilicate glass. The crystallized glass is, for example, lithium system crystallized glass. As the ceramic substrate, a sintered compact that is mainly formed from aluminum oxide, aluminum nitride, silicon nitride, etc. and a fiber reinforced material can be used. Further, a thin film such as a NiP layer can be formed on a surface of the above-described metal substrate or nonmetal substrate by a plating method or a sputtering method. The effect obtained when sputtering is used as a method of forming the thin film on the substrate can be also obtained when a vacuum deposition, electroplating, etc. are used.

Between the substrate 1, which is formed of nonmagnetic material, and the magnetic recording layer 5, an adhesion layer 2, a soft magnetic under layer (SUL) 3, and a nonmagnetic under layer 4 can be formed, as shown in FIG. 9.

The adhesion layer 2 is provided to improve the adhesion with the substrate 1. As a material of the adhesion layer 2, Ti, Ta, W, Cr, Pt, or alloys containing these, which has an amorphous structure, or oxides thereof or nitride thereof can be used.

The adhesion layer 2 may have a thickness of 5 nm through 30 nm, for example.

When the thickness is less than 5 nm, sufficient adhesion may not be obtained. Thus, the adhesion layer 2 may come off. When the thickness exceeds 30 nm, the process time become longer and throughput tends to be lower.

The soft magnetic under layer (SUL) 3 allows a recording magnetic field to go through in a parallel direction from a single pole head to magnetize a perpendicular magnetic recording layer, and allows the recording magnetic field reflux to return to the magnetic head side. Thereby, the SUL 3 applies a steep and sufficient perpendicular magnetic field to the recording layer in the magnetic field, and this improves the recording and reproducing efficiency. As such material, a Co alloy containing Co and at least one of Zr, Hf, Nb, Ta, Ti, and Y can be used. The Co alloy can contain Co of 80 atom % or more. When a film is formed of such a Co alloy using a sputtering method, an amorphous layer is more likely to be formed. An amorphous soft magnetic material does not have crystal magnetic anisotropy, a crystal defect, or grain boundary, and thereby an excellent soft magnetic property is obtained, and it is possible to lower the noise of the medium. As a preferred amorphous soft magnetic material, CoZr, CoZrNb, a CoZrTa system alloy, etc. can be used, for example. As other materials of the soft magnetic under layer 3, a CoFe system alloy such as CoFe, CoFeV, etc, a FeNi system alloy such as FeNi, FeNiMo, FeNiCr, FeNiSi, etc., a FeAl system alloy, a FeSi system alloy such as FeAl, FeAlSi, FeAlSiCr, FeAlSiTiRu, FeAlO, etc., a FeTa system alloy such as FeTa, FeTaC, FeTaN, etc., and a FeZr system alloy such as FeZrN, etc., can be used. Moreover, a material that has a granular structure in which micro crystallite structure or minute crystalline particles of FeAlO, FeMgO, FeTaN, FeZrN, etc. that contains Fe of 60 atom % is distributed in the matrix can also be used.

The soft magnetic under layer 3 may have a thickness of 10 through 100 nm, for example.

When the thickness is less than 10 nm, the recording magnetic field from the magnetic head may not sufficiently flow, in which case the recording and reproducing efficiency cannot improve. When the thickness exceeds 100 nm, the process time becomes longer and the throughput tends to be lower.

Furthermore, in order to prevent spike noise, the soft magnetic under layer 3 may be divided into a plurality of layers to obtain anti-ferromagnetic coupling by inserting a nonmagnetic division layer of 0.5-1.5 nm. Moreover, a pinned layer and a soft magnetic layer may be exchange-coupled. The pinned layer is formed of a hard magnetic film having in-plane anisotropy such as CoCrPt, SmCo, FePt, etc. or an anti-ferromagnetic body such as IrMn, PtMn, etc. In order to control exchange-coupling power, magnetic films such as Co, for example, or nonmagnetic films such as Pt, for example, can be laminated above and under the nonmagnetic division layer.

The nonmagnetic under layer 4 is formed such that the magnetic recording layer 5 is formed on and in contact with the nonmagnetic under layer 4. By being in contact with the magnetic recording layer 5, the non magnetic under layer 4 can alter the crystalline orientation property and a crystal grain size of the magnetic recording layer 5. As the nonmagnetic under layer 4, at least one of a Ru alloy, a Ni alloy, a Pt alloy, a Pd alloy, a Ta alloy, a Cr alloy, a Si alloy, and a Cu alloy can be used, for example. The film thickness of the nonmagnetic under layer 4 is desirably 1 nm or more and 20 nm or less. When the film thickness of an orientation control layer is less than 1 nm, the effect of the nonmagnetic under layer 4 is insufficient, and thereby there is a tendency that the crystal orientation property gets worse. On the other hand, when the film thickness of the nonmagnetic under layer 3 exceeds 20 nm, there is a tendency for spacing loss to occur, where the increased spacing between SUL and the magnetic head causes a decrease in the magnetic field gradient from the magnetic head to make writability worse. Moreover, the nonmagnetic under layer 3 may be formed from a plurality of layers and not from one layer.

The magnetic recording layer 5 can be mainly formed from one of iron and cobalt, and platinum. Moreover, it is desirable to use a perpendicular magnetic recording layer that has magnetic anisotropy in a direction perpendicular to the surface of the substrate 1. When the perpendicular magnetic recording layer is used, under a high density situation, an external magnetic field from a recording dot works to keep the direction of signals of recording dots in the periphery the recording dot. Therefore, the signal erasure due to thermal fluctuation is less likely to occur, and there is a tendency that the higher density can be more likely achieved.

The thickness of the magnetic recording layer 5 can be set to be 3 through 30 nm, more specifically 5 through 15 nm, for example. When the thickness is in this range, a magnetic recording and reproducing device that is more suitable for even higher recording density can be produced. When the thickness of the magnetic recording layer 5 is less than 3 nm, a noise component in a signal tends to increase because a reproduction output is too low. When the thickness of the magnetic recording layer 5 exceeds 30 nm, a waveform tends to be distorted because the reproduction output is too high. The magnetic recording layer 5 may also be made from a laminated film having two or more layers, and in that case, the total thickness of the laminated film can be set in the above-described range. Coercive force of the magnetic recording layer 5 can be set to be 237,000 A/m (3,000 Oe) or more. When the coercive force is less than 237,000 A/m (3,000 Oe), tolerance to thermal fluctuation becomes inferior. The perpendicular squareness ratio, where means the ratio of residual magnetization (Mr) to saturation magnetization (Ms) in the hysteresis loop, of the magnetic recording layer 5 is preferably 0.8 or more. When the perpendicular squareness ratio is less than 0.8, the thermal fluctuation tolerance tends to be insufficient.

The Pt content of the magnetic recording layer 5 is preferably 10 atom % or more and 25 atom % or less. The reason why the above-described range is preferable as Pt content is as follows: a uniaxial crystal magnetic anisotropy constant (Ku) that the magnetic recording layer 5 needs can be obtained; the crystal orientation property of the magnetic grains are good; and as a result, the thermal fluctuation characteristic and recording and reproducing characteristic that are suitable for the high density recording can be obtained. On the other hand, when the Pt content exceeds the above-described range or when the Pt content is less than the above-described range, there is a tendency that sufficient Ku for the thermal fluctuation characteristic that is suitable for the high density recording cannot be obtained.

The protective film 6 is provided for the purpose of preventing corrosion of the magnetic recording layer 5 and also to prevent the surface of the medium from being damaged when the magnetic head contacts the medium. As a material of the protective film 6, a substance containing C is used, for example. The thickness of the protective film 6 is preferably 1 through 10 nm, because the head can be positioned close enough to the medium, enabling the high density recording. Carbon can be classified into sp² combined carbon (graphite) and sp³ combined carbon (diamond). The sp³ combined carbon has better durability and corrosion resistance, but graphite has better surface smoothness due to the crystalline material. Usually, film formation of carbon is performed by a sputtering method using a graphite target. By this method, an amorphous carbon in which sp² combined carbon and sp³ combined carbon are mixed. Carbon material in which proportion of sp³ combined carbon is large is called diamond-like carbon (DLC), and has advantage in durability and corrosion resistance, and also has advantage in surface smoothness because it is amorphous. Therefore, DLC is used for the surface protective film for the magnetic recording layer 5. In the film formation of DLC by a CVD method, DLC is generated by a chemical reaction caused by exciting and decomposing a source gas in plasma. Therefore, DLC that contains more sp³ combined carbon can be formed by adjusting conditions.

The grain-state mask layer 9 is used to create the projection pattern of the magnetic recording layer 5. For example, because the standard deviation of the grain size of normal polycrystalline grains is 20% or more, the standard deviation that is less than it is desirable. Specifically, in the grain-state mask layer 9, a standard deviation σ of grain size is preferably 15% or less. The grain-state mask layer 9, a film whose standard deviation of grain size is low, which is a self-organization film, can be formed when film formation is performed at a pressure (0.3 Pa or less) of Ar, which is lower than the normal pressure (about 0.7 Pa) using one of Si and Ge as the grain boundary 8 and using Al as the grains 7. At this time, Al works as the grains 7 and one of Si and Ge works as the grain boundary 8. In addition, an Al compound such as Al2O3 cannot be used as the grains 7, and a Si compound such as SiO2 or a Ge compound such as GeO2 cannot be used as the grain boundary 8. If the Al2O3 compound for the grains and the Si compound such as SiO2 or the Ge compound such as GeO2 is used instead of Si or Ge, a target grain-state mask layer whose standard deviation of grain size of grains is 15% or less cannot be obtained.

In the grain-state mask layer 9, the average grain size of the grains 7 is approximately 4 nm-9 nm, and the average size of the grain boundary 8 is approximately 1 nm-5 nm. The standard deviation of the grains size is 8-15%. Since the grain size does not increase even if the film thickness increases, the grain size is constant regardless of the thickness of the film. Therefore, it is easy to obtain the a high aspect ratio of the film thickness with respect to the grain size. When a thicker mask layer is used the processability gets worse. However, as long as there is no issue of the processability, the film thickness of the grain-state mask layer 9 is preferably formed thicker as far as the sufficient processability is assured.

Hereinafter, examples are described to explain the embodiment in more detail.

FIGS. 9 through 15 respectively illustrate other examples of manufacturing the magnetic recording medium according to the embodiment.

### Example 1 and 2

As illustrated in FIG. 9, a glass substrate 1 (amorphous substrate MEL6 by Konica Minolta Co., Ltd., 2.5 inches in diameter) was prepared, and accommodated in a film formation chamber of a DC magnetron sputtering device (C-3010 by CANON ANELVA CORPORATION), and the inside of the film formation chamber was evacuated to 1×10⁻⁵ Pa of ultimate vacuum. Then, Ar gas was introduced into the film formation chamber until the gas pressure becomes 0.7 Pa, and CrTi having 10 nm was formed as the adhesion layer 2 at 1,000 W DC.

Then, on the adhesion layer 2, a film of CoFeTaZr having the thickness of 40 nm was formed as the soft magnetic under layer 3 at 1,000 W DC. Thereby, a soft magnetic under layer 3 was formed.

Then, on the soft magnetic under layer 3, as the nonmagnetic under layer 4, Ru having a thickness of 15 nm was formed at 1,000 W DC. Thereafter, as the magnetic recording layer 5 having perpendicular anisotropy, a film containing Co and Pt of 20 atm % having the thickness of 10 nm was formed at 1,000 W DC on the nonmagnetic under layer 4.

Furthermore, as illustrated in FIG. 10, by the CVD method, the DLC protective layer 6 having the thickness of 5 nm was formed on the magnetic recording layer 5, and a main body of the magnetic recording medium 20 was obtained.

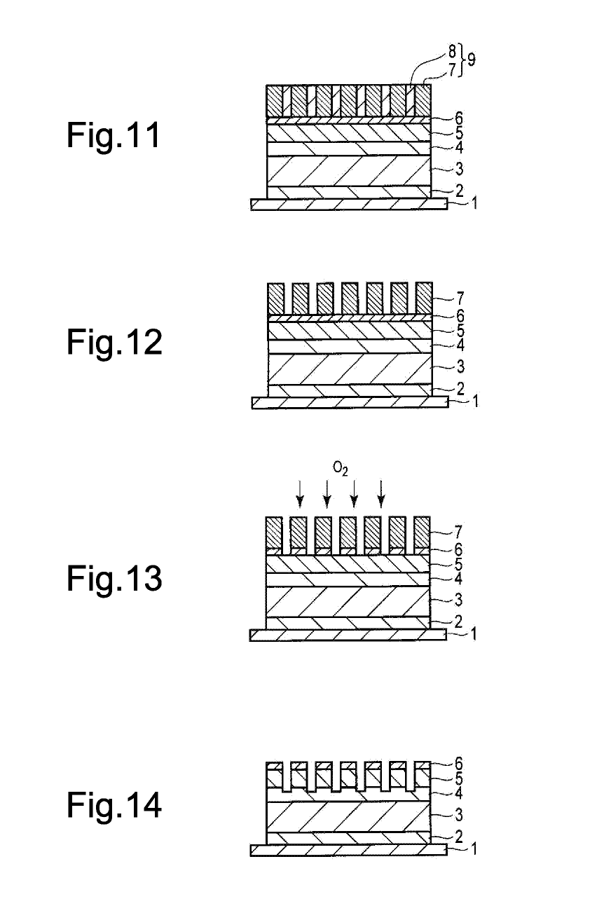

Next, Ar gas was introduced into the film formation chamber such that a gas pressure becomes 0.1 Pa. As illustrated in FIG. 11, a film formed of Al and Si of 50 atm % and having a thickness of 30 nm was formed at 300 W RF. When film formation was performed at a gas pressure of approximately 0.1 Pa, which was lower than the normal gas pressure of 0.7 Pa, a grain-state mask layer 9 having Al grains 7, which were grains whose standard deviation of grain size was approximately 10%, and a Si grain boundary 8 provided between the Al grains 7 was obtained.

Next, a patterned medium was produced as described below.

Initially, as illustrated in FIG. 12, an inductively-coupled plasma—reactive ion etching (ICP-RIE) device was used. CF₄ was used as the process gas. A chamber pressure was set to be 0.1 Pa. Antenna power and bias power were respectively set to be 50 W and 2 W. Etching time was set for 60 seconds. Dry etching of the Si grain boundary 8 of the grain-state mask layer 9 was performed. The Si grain boundary 8 was removed to expose the surface of the DLC protective layer 6 in the projection part.

Next, as illustrated in FIG. 13, the surfaces of the Al grains 7 of the grain-state mask layer 9 were oxidized, and at the same time the DLC protective layer 6 was processed. An Al oxide has a slower milling rate than that of a not-oxidized Al grain. Therefore, when an oxidization process of the Al grains 7 was performed, the process time can be gained during the transfer of the magnetic recording layer, which will be described below. The DLC protective 6 was etched as illustrated in FIG. 13. Specifically, after the medium (the laminated structure) was heated to 100° C., and the projection pattern of the Al grains 7 was used for a mask; the ICP-RIE device was used; O₂ was used as process gas; chamber pressure was set to be 0.1 Pa; antenna power and bias power were respectively set to be 50 W and 2 W; etching time was set to 10 seconds. As a result, the surface of the Al grains 7 was oxidized and the projection pattern of the Al grains 7 was transferred to the DLC protective layer 6. In addition, the surface of the magnetic recording layer 5 was exposed between the adjacent projection parts of the Al grains 7 (i.e., the part where the Si grain boundary 8 was removed).

Next, the magnetic recording layer 5 was etched and the projection patterns of the Al grains 7 and the protective layer 6 was transferred as illustrated in FIG. 14. Specifically, the magnetic recording layer 5 was patterned using the oxidized Al grains 7 and the DLC protective layer 6 directly under the Al grains 7 as a patterned mask. For the etching of the magnetic recording layer 5, an ion milling device was used; Ar gas was used; the gas pressure was set to be 0.06 Pa; the acceleration voltage was set to be 400 V; and the etching time was set to 30 seconds. Here, although the oxidized Al grains 7 oxidized by Ar ion were also removed during the etching process, the DLC protective layer 6 also worked as a stopper layer because the milling rate of the DLC protective layer 6 is slower. The conditions for over etching can be used so that the residual substance of the aluminum grains 7, which are masks, may not remain. At the same time, the recording dot parts (projection parts) of the magnetic recording layer 5 can also be protected.

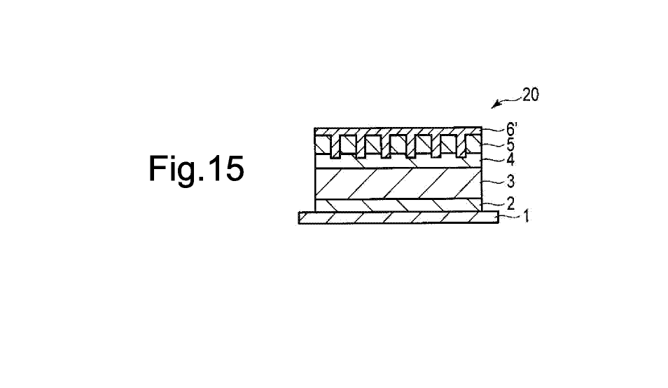

Next, as illustrated in FIG. 15, a patterned type perpendicular magnetic recording medium 10 according to the first example was obtained as follows: on the nonmagnetic under layer 4, the patter-transferred magnetic recording layer 5, and the pattern-transferred protective layer 6, a DLC protective layer 6′ having the thickness of 20 nm was formed by a CVD method; then planarization process was performed; and a lubricant (not shown) was applied by a dipping method.

Patterned-type perpendicular magnetic recording media according to an example 2 and comparative examples 1-13 were obtained as follows: as component elements of a first ingredient (grains 7) and a second ingredient (grain boundary 8) of the grain-state mask layer 9, combinations of ones selected from Al, Ti, Cr, Cu, Si and Ge, which are shown in Table 1, were used; the sputtering conditions were varied as described in Table 1; the method other than the combination of the component elements and the sputtering conditions is the same as the first example. In each of the examples and the comparative examples, a laminated structure after the grain-state mask layer 9 having the same configuration as the one illustrated in FIG. 11, was formed, and its cross section, a grain structure in the plan direction, and element composition of each part were examined. Specifically, the sizes of the projection pattern of the medium, and the element composition of the grain-state mask layer 9 were measured using a transmission electron microscope (TEM) and an energy dispersive X-ray spectroscopy (TEM-EDX).

First, in each of the examples and the comparative examples, the sizes and the element composition of the projection pattern of the medium in which the grain-state mask layer 9 was formed were examined.

As a result, in the media of the examples 1 and 2, the grains 7 of the grain-state mask layer were formed from Al and had the grain size of approximately 7 nm, and the grain boundary 8 was formed from Si or Ge and had a thickness of approximately 2 nm. The standard deviation of the grain size of the Al grains 7 was 11-12%.

On the other hand, the media of the comparative examples 1-3 had a so-called polycrystalline structure in which adjacent grains contact each other, and the thickness of the grain boundary 8 was not measurable because the thickness was too thin. Also, as shown in Table 1, the grains contained both Al and Ti (or Cr and Cu).

In the media of the comparative examples 4-9, the grains 7 were formed from one of Al, Ti, Cr, and Cu, and the grain boundary 8 was formed from Si or Ge, and the thickness of the grain boundary 8 was approximately 1 nm. However, the standard deviation of the grain size was 20% or more, which is large.

In the media of the comparative examples 10-13, the grains 7 was formed of Al, the grain boundary 8 was formed of Si or Ge, and the thickness of the grain boundary 8 was approximately 1 nm. However, the standard deviation of the grain size was 20% or more, which is large, and a characteristic that the standard deviation of the grain size is especially small was not found.

In the same manner, in each of the examples and comparative examples, the structure and the element composition of the projection pattern of the magnetic recording layer 5, after the magnetic recording layer 5 was patterned, was examined. The following Table 1 shows the standard deviation of the pattern size of the magnetic recording layer 5. It was found that the standard deviation examined here has the same characteristic as the standard deviation of the grain size of the grains having the grain structure in which the grain-state mask layer has been formed as described above.

Further, with respect to the media according to the examples 1 and 2 and the media according to the comparative examples 1-13, in which the process of the magnetic recording layer has been completed, the sizes of the projection pattern along its cross section and in the plane direction, and the recording and reproducing characteristic was examined.

In the evaluation of the recording and reproducing characteristic, an electromagnetic conversion characteristic was measured using a read/write analyzer “RWA1632” and a spin stand “S1701MP, which are manufactured by Guzik Co., in the USA.

Specifically, as the evaluation of the recording and reproducing characteristic, a shielded pole magnetic pole was used for writing, and a head using a TMR element was used for a reproducing part. The shielded pole magnetic pole is a single-pole pole having a shield (the shield works to induce a magnetic flux generated from the magnetic head). A SNR was measured as the condition of the recording frequency was set to match the frequency of the recording dots.

As illustrated in Table 1, preferable SNRs were obtained for the media according to the examples 1 and 2. It can be considered that this is because the standard deviation of the pattern size of the magnetic recording layer 5 was low.

On the other hand, as compared to the media according to the examples 1 and 2, the SNRs of the media according to the comparative examples 1-13 were found to be lower. As its reasons, it can be considered as a reason for the media according to the comparative examples 1-3 that the separation between the grains 7 and the grain boundary 8 was not sufficient so that the standard deviation of the pattern size of the magnetic recording layer 5 became large. In the media according to the comparative examples 4-13, a specific grain/grain boundary structure has been formed at the stage of processing the mask layer. Therefore, although transfer to the magnetic recording layer 5 was performed, the improvement in the recording and reproducing characteristic was not found because any specific improvement in the standard deviation of the grain size was not found.

TABLE 1

| | | | | Standard Deviation | |
|---|---|---|---|---|---|
| | | Grain | Sputtering Condition | (%) of Projection | SNR |
| | Grains | Boundary | (Power, Ar Pressure) | Pattern Size | (dB) |
| Example 1 | Al | Si | RF300W, 0.1 Pa | 11% | 22.4 |
| Example 2 | Al | Ge | RF300W, 0.1 Pa | 12% | 22.1 |
| Comparative Example 1 | AlTi | — | RF300W, 0.1 Pa | 36% | 12.3 |
| Comparative Example 2 | AlCr | — | RF300W, 0.1 Pa | 32% | 11.3 |
| Comparative Example 3 | AlCu | — | RF300W, 0.1 Pa | 38% | 11.6 |
| Comparative Example 4 | Ti | Si | RF300W, 0.1 Pa | 27% | 12.1 |
| Comparative Example 5 | Cr | Si | RF300W, 0.1 Pa | 25% | 12.3 |
| Comparative Example 6 | Cu | Si | RF300W, 0.1 Pa | 24% | 12.4 |
| Comparative Example 7 | Ti | Ge | RF300W, 0.1 Pa | 27% | 12.1 |
| Comparative Example 8 | Cr | Ge | RF300W, 0.1 Pa | 26% | 12.2 |
| Comparative Example 9 | Cu | Ge | RF300W, 0.1 Pa | 23% | 14.4 |
| Comparative Example 10 | Al | Si | RF300W, 0.7 Pa | 22% | 16.7 |
| Comparative Example 11 | Al | Ge | RF300W, 0.7 Pa | 25% | 16.3 |
| Comparative Example 12 | Al | Si | RF300W, 0.7 Pa | 28% | 13.7 |
| Comparative Example 13 | Al | Ge | RF300W, 0.7 Pa | 29% | 13.4 |

### Comparative Examples 14-21

Media for a comparative example 14 (Si grain boundary) and a comparative example 15 (Ge grain boundary) were produced in the same way as the examples 1 and 2 except for processing the DLC protective layer 6 without oxidizing the surface of the Al grains 7 of the grain-state mask layer 9 without heating the media to approximately 100° C. during the transferring from the grain-state mask layer 7 to the DLC protective layer 6.

Also, media for a comparative example 16 (Si grain boundary) and a media for a comparative example 17 (Ge grain boundary) were produced in the same method as the examples 1 and 2 except for that the DLC protective 6 was not used.

Also, media for a comparative example 18 (Si grain boundary, O₂), a comparative example 19 (Ge grain boundary, O₂), a comparative example 20 (Si grain boundary, Ar), and a comparative example 21 (Ge grain boundary, Ar) were produced in the same way except for that oxygen or Ar instead of CF₄, which is fluorine system gas, was used as illustrated in Table 2 during the removal of the grain boundary 8 of the grain-state mask layer 9.

Further, in the same way as the example 1, in the media of the comparative example 14-21, the projection pattern structure along its cross section and in the plane direction and the standard deviation of the projection pattern size, and the recording and reproducing characteristic were measured.

Moreover, in the media of the examples 1 and 2 and comparative examples 14, 15, and 18-21, the laminated structure after the pattern of the grains 7 was transferred to the DLC protective layer 6 as illustrated in FIG. 13 was sampled. Specifically, a grain structure along its cross section and in the plane direction was examined using a TEM, and an element composition of each part was examined using a TEM-EDX.

Moreover, in the media of the examples 1 and 2 and the comparative examples 14-21, the laminated structure after the pattern of the grains 7 are transferred to the magnetic recording layer 5 as illustrated in FIG. 14 was sampled. Specifically, a grain structure along its cross section and in the plane direction was examined using a TEM, and an element composition of each part was examined using a TEM-EDX.

At first, in the examples 1 and 2 and the comparative examples 14, 15, and 18-21, the standard deviation of the projection pattern size of the protective layer 6 of the medium in the stage that the transfer of the DLC protective layer 6 has been performed and its element composition were examined.

As a result, it was found that in the media of the examples 1 and 2, the pattern of the grains 7 of the grain-state mask layer was transferred to the DLC protective layer 6, and that the surface of the magnetic recording layer 5 was exposed. Also, it was found that the surface of the Al grains 7 having the projection shape was covered by the oxide aluminum having the thickness of approximately 1-2 nm.

On the other hand, it was found that in the comparative examples 14 and 15, as in the examples 1 and 2, the pattern of the grains 7 of the grain-state mask layer was transferred to the DLC protective layer 6, and that the surface of the magnetic recording layer 5 was exposed. However, the oxide layer cannot be observed on the surface of the Al grains 7 having the projection shape.

Also, in the media of the comparative examples 18 and 19, it was found that the substance of the grain boundary 8 was not removed and that the pattern of the grains 7 of the grain-state mask layer was not transferred to the DLC protective layer 6. The considerable reasons why the grain boundary of the media of the comparative examples 18 and 19 was not able to be removed is as follows: the grain boundary 8 substance reacted to O₂ so that the grain boundary substance turned to silicon oxide or germanium oxide and it remained in the grain boundary 8 without being changed because it is not volatile. In addition, it was found that the surface of the Al grains 7 has turned into an aluminum oxide layer having a thickness of approximately 1-2 nm.

In the same manner, in the media of the comparative examples 20 and 21, it was found that the substance of the grain boundary 8 was not removed and that the structure of the grain state mask layer was not transferred to the DLC protective layer 6. The considerable reason why the grain boundary of the media of the comparative examples 20 and 21 was not able to be removed is that the material of the grain boundary 8 doesn't react with Ar so that the material remained in the grain boundary 8.

Then, in the examples 1 and 2 and the comparative examples 14-21, the grain structure of the media at the stage that the transfer to the magnetic recording layer has been performed and its element composition were examined. As a result, in the media of the examples 1 and 2, the Ru nonmagnetic under layer 4 was partially etched by approximately 1-3 nm. However, the DLC protective layer 6 having the thickness of approximately 2-3 nm remained on the projection parts of the recording dots. Also, it was found that the magnetic recording layer 5 was patterned with a thickness of 10 nm.

On the other hand, in the media of the comparative examples 14 and 15, it was observed that the nonmagnetic under layer 4 was etched by approximately 1-3 nm in the same manner as the examples 1 and 2. In addition, the DLC protective layer 6 on the recording dot part of the projection part was partially etched, and the thickness of the magnetic recording layer 5 under those regions recording part was partially reduced to approximately 8-9 nm. A main reason for this is that the DLC protective layer 6 was removed during the milling process of the magnetic recording layer because the Al grains 7 didn't have sufficient tolerance as a mask so that the DLC protective layer and the recording dot part of the magnetic recording layer were trimmed.

Next, in the media of the comparative examples 16 and 17, it was observed that the nonmagnetic under layer 4 was etched by approximately 1-3 nm in the same manner as the examples 1 and 2. In addition, the projection part of the magnetic recording layer 5 was etched and the thickness was reduced to approximately 5-8 nm. The considerable reason why the recording dot part of the magnetic recording layer was trimmed is that no DLC protective film was provided so a layer that works as a stopper when the oxidized Al grain mask was removed was not provided.

In the media of the comparative examples 18-21, it was found that, because the grain-state mask layer was not sufficiently processed, the DLC protective layer 6 and the magnetic recording layer 5 were not processed so that the structure was not transferred to the magnetic layer.

At last, in the media of the examples 1 and 2 and the comparative examples 14-21, in which the magnetic recording layer 5 was patterned, the evaluation of the recording and reproducing characteristic was performed in the same way as the example 1. As shown in Table 2, as compared to the media of the examples of the present application, in the media of the comparative examples 14-21, it is found that the property thereof got worse. It can be considered as its reason that, because the media of the comparative examples 14-17 had the variation in the thickness of the recording dot, the dispersion of the volume of the recording dots got worse and the variation occurred in signals, and thereby the recording and reproducing characteristic got worse. Also, it was considered that, in the media of the comparative examples 18-21, because the magnetic recording layer 5 was not processed, appropriate recording and reproducing were not able to be performed.

Also, in the process conditions of the comparative examples 14-17 in the present application, the priority was put on the trimming of the entire part of the recording layer, and thereby the top layer part of the recording dots was also trimmed. On the other hand, when the priority was put on the not-trimming of the recording dots, the magnetic recording layer 5 would not be entirely trimmed, and the adjacent recording dots are linked to each other in the initial part of the magnetic recording layer. As a result, the characteristic got worse.

TABLE 2

| | | | | Heating of Grains | Etching Gas | |
|---|---|---|---|---|---|---|
| | | Grain | DLC Protective | after Removal of | of Grain | SNR |
| | Grains | Boundary | Layer | Grain Boundary | Boundary | (dB) |
| Example 1 | Al | Si | With | With | CF₄ | 22.4 |
| Example 2 | Al | Ge | With | With | CF₄ | 22.1 |
| Comparative Example 14 | Al | Si | With | Without | CF₄ | 17.5 |
| Comparative Example 15 | Al | Ge | With | Without | CF₄ | 17.2 |
| Comparative Example 16 | Al | Si | Without | With | CF₄ | 16.6 |
| Comparative Example 17 | Al | Ge | Without | With | CF₄ | 16.1 |
| Comparative Example 18 | Al | Si | With | With | O₂ | 5.3 |
| Comparative Example 19 | Al | Ge | With | With | O₂ | 4.8 |
| Comparative Example 20 | Al | Si | With | With | Ar | 6.3 |
| Comparative Example 21 | Al | Ge | With | With | Ar | 6.0 |

### Examples 3 and 4 and Comparative Examples 22 and 23

The pressure at which the grain-state mask layer 9 was formed was changed to 0.01 Pa-1.0 Pa as illustrated in the following Table 3, and in the same way as the example 1 except for that the grain-state mask layer was formed, the media of the examples 3 and 4 and the media of the comparative examples 22 and 23 were obtained. The result at 0.01 Pa was not described because the Ar pressure was too low and discharge didn't occur so that the film was not able to be formed.

In the perpendicular magnetic recording media of the examples 3 and 4 and the media of the comparative examples 22 and 23, the structure and the size of the projection pattern along the cross section and in the plane direction, and its recording and reproducing characteristic was measured. Moreover, with respect to the examples and the comparative examples, the laminated structure after the grain-state mask layer 9 was formed (corresponding to FIG. 11) was examined, and the grain structure along the cross section and the plane direction and the element composition of each part were examined.

The grain structure of the laminated structure and its element composition in the media of the examples 3 and 4 were as follows: the grains 7 were made from Al; the grain size was approximately 7 nm; the grain boundary 8 was formed from Si and had a thickness of approximately 2 nm; and the standard deviation σ of the grain size of the Al grains 7 was 11-14%.

On the other hand, in the media of the comparative examples 22 and 23, the grains 7 were formed from Al, the grain boundary 8 was formed from Si, and the thickness of the grain boundary 8 was approximately 1 nm, and standard deviation of the grain boundary thickness was 20% or more, which is large. Thereby, the characteristic that the standard deviation of the grain boundary thickness was specifically small was not observed.

In the same manner, with respect to the examples and the comparative examples, the structure and the size of the projection pattern of the magnetic recording layer 5 after the magnetic recording layer 5 was patterned and its element composition were examined. The standard deviation of the projection pattern size is shown in Table 3. As illustrated in Table 3, it was found that the characteristic in this case was the same as the characteristic of the grain structure in the above-described case that the grain-state mask layer has been formed.

With respect to the media of the examples 3 and 4 and the comparative examples 22 and 23, in which the magnetic recording layer 5 has been processed using this mask, the recording and reproducing characteristic was evaluated in the same way as the example 1.

As shown in Table 3, the media of the example 1, 3 and 4 showed higher SNR than the media of the comparative examples 22 and 23. It was considered that this is because the standard deviation of the projection pattern size of the magnetic recording layer 5 was low.

On the other hand, the media of the comparative examples 10, 22, and 23 showed lower SNR than the examples 1, 3, and 4. Therefore, although the pattern of the grains 7 was properly transferred to the magnetic recording layer 5, the specific improvement in the standard deviation of the grain size was not observed. Thereby, it was considered that the improvement in the recording and reproducing characteristic was also not observed.

TABLE 3

| | Sputtering | Standard Deviation | |
|---|---|---|---|
| | Pressure | (%) of Projection | SNR |
| | (Pa) | Pattern Size | (dB) |
| Example 3 | 0.05 | 11 | 22.5 |
| Example 1 | 0.1 | 11 | 22.4 |
| Example 4 | 0.3 | 14 | 21.1 |
| Comparative Example 22 | 0.5 | 21 | 16.9 |
| Comparative Example 10 | 0.7 | 22 | 16.7 |
| Comparative Example 23 | 1.0 | 25 | 15.8 |

While certain embodiments have been described, these embodiments have been presented by way of example only; and are not intended to limit the scope of the inventions. Indeed, the novel embodiments described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirits of the inventions.

What is claimed is:

1. A method of manufacturing a magnetic recording medium: comprising:
forming a magnetic recording layer on a substrate;
forming a protective layer on the magnetic recording layer;
executing a sputtering process using a target containing a first ingredient and a second ingredient to form on the protective layer a grain-state mask layer that includes grains formed of the first ingredient and grain boundaries between the grains formed of the second ingredient;
etching the grain boundaries so that a projection pattern of the grains is formed; and
transferring the projection pattern of the grains to the magnetic recording layer.

2. The method according to claim 1, wherein the transferring includes:
etching the magnetic recording layer is etched using gas containing Ar.

3. The method according to claim 1, wherein the transferring includes:
etching the protective layer exposing between the projection pattern of the grains so that the magnetic recording layer formed under the protective layer is exposed; and
ion milling the exposed magnetic recording layer.

4. The method according to claim 1, wherein the sputtering is conducted under a pressure of 0.05 Pa through 0.3 Pa.

5. The method according to claim 1, wherein the first ingredient is aluminum.

6. The method according to claim 1, wherein the second ingredient is silicon or germanium.

7. The method according to claim 1, wherein the sputtering is performed by a RF sputtering.

8. The method according to claim 1, wherein the grain boundary is etched using gas containing fluorine.

9. The method according to claim 1, further comprising:
oxidizing surfaces of the grains before transferring the projection pattern of the grains to the magnetic recording layer.

10. The method according to claim 1, wherein
the protective layer is formed from a diamond-like carbon.

11. The method according to claim 1, wherein
all of the processes are conducted by a dry process.

12. A magnetic recording medium comprising:
a substrate;
a magnetic recording layer formed on the substrate; and
a protective layer formed on the magnetic recording layer,
wherein the magnetic recording layer has a plurality of projection patterns, and an average distance between centers of the adjacent projections is 5 nm through 10 nm.

13. The magnetic recording medium according to claim 12, wherein
a standard deviation of the width of the projections is 15% or less.

14. The magnetic recording medium according to claim 13, wherein
an average width of the projections is 4 nm through 9 nm.

15. The magnetic recording medium according to claim 12, wherein
an average width of the projections is 4 through 9 nm.

16. The magnetic recording medium according to claim 12, wherein
the projection patterns are patterned along a circumferential direction of the magnetic recording medium.

17. A magnetic recording medium comprising:
a substrate;
a magnetic recording layer formed on the substrate; and
a protective layer formed on the magnetic recording layer,
wherein the magnetic recording layer has a plurality of projections, and a standard deviation of the width of the projections is 15% or less.

18. The magnetic recording medium according to claim 17, wherein
an average width of the projections is 4 through 9 nm.

19. The magnetic recording medium according to claim 17, further comprising:
a protective layer formed on the magnetic recording layer and comprised of a diamond-like carbon.

20. The magnetic recording medium according to claim 17, wherein
the projections are patterned along a circumferential direction of the magnetic recording medium.

21. The magnetic recording medium according to claim 20, wherein
the projections are patterned along a radial direction of the magnetic recording medium.
